(19) United States
(12) Patent Application Publication
(10) Pub. No.: US 2004/0244833 A1
(43) Pub. Date: Dec. 9, 2004

(54) Rain detector for automatic irrigation systems

(76) Inventor: Kirk Buhler, Corona, CA (US)

Correspondence Address: Robert D. Fish, Rutan & Tucker LLP, Suite 1400, 611 Anton Blvd., Costa Mesa, CA, 92626, US

(21) Appl. No.: 10/455,871

(22) Filed: Jun. 5, 2003

Related U.S. Application Data
(63) Continuation-in-part of application No. 10/048,443, filed on Mar. 8, 2004.

(51) Int. Cl. F16K 17/36

(52) U.S. Cl. 137/78.2

(57) ABSTRACT

A rain detector comprises a porous material, a sensor that detects rain absorption by the porous material and a switching mechanism that is linked to the sensor to effect an execution of an irrigation application by an irrigation controller. The porous material may be composed of brick or other substance with porous properties. When the sensor does not detect any rain absorption by the porous material, the switching mechanism will remain in the closed position providing an electrical connection between the irrigation controller and at least one sprinkler valve, thereby allowing the execution of an irrigation application by the irrigation controller. When the sensor detects rain absorption by the porous material, the switching mechanism will be in the open position. When the switching mechanism is in the open position there is provided an electrical disconnection between the irrigation controller and at least one sprinkler valve, thereby preventing the execution of an irrigation application by the irrigation controller.

This application claims the benefit of U.S. utility application Ser. No. 10/048,443 filed on Jan. 29, 2002, incorporated herein by reference in its entirety.

### FIELD OF THE INVENTION

The field of the invention is rain detectors.

### BACKGROUND OF THE INVENTION

In arid areas of the world water is becoming one of the most precious natural resources. Meeting future water needs in these arid areas may require aggressive conservation measures. This requires irrigation systems that apply water to the landscape based on the water requirements of the plants and also limits the automatic irrigation of the landscape when adequate moisture is occurring due to natural rainfall. Automatic irrigation controllers control the release of water to the various zones by the automatic activation of irrigation valves. Today, some irrigation systems have rain detectors that automatically override the activation of irrigation valves when rain occurs. This prevents excessive water from being applied to the landscape that is both detrimental to the plants and is also a waste of water.

Three rain detectors use conductive sensors that protrude downward into a rain collector to detect rainfall and are discussed in U.S. Pat. No. 4,613,764, issued September, 1986 to Lobato, U.S. Pat. No. 5,312,578, issued June, 1994 to Morrison et. al. and U.S. Pat. No. 5,355,122 issued October, 1994 to Erickson. Since the conductive sensors protrude downward into the collection tray, the opening of the collection tray is partially obstructed. The obstruction of the opening effects the collection of rain and the subsequent evaporation of the collected rainwater from the collection tray. With these three rain detectors, the resumption of the operation of the irrigation system is partly effected by the evaporation of the rainwater from the rain collection tray. When evaporation of the water occurs, the conductive sensors will no longer extend into the water and the irrigation system will resume operation again. Since the housing, holding the conductive sensors, partially covers the collection tray the evaporation of the water from the collection tray may vary and not correlate with evaporation that would occur under natural conditions. This may result in the irrigation system being activated either before or after the preferred time for resumption of the irrigation to begin again.

Other rain detectors use hygroscopic materials to override an automatic irrigation schedule and are discussed in U.S. Pat. No. 5,101,083, issued March, 1992 to Tyler, et al. and U.S. Pat. No. 6,452,499, issued September, 2002 to Runge, et. al. The hygroscopic materials expand upon absorbing rainwater and activate a switch to prevent the irrigation system from operating. It may be difficult to determine the quantity of water required to prevent the irrigation system from operating since the absorptive properties of the absorptive medium may vary.

It is also known for rain detectors to provide a means for modifying an irrigation schedule so that subsequent irrigation applications apply less water than would otherwise be applied. For this purpose, however, it is not sufficient merely to detect rainfall. Instead the system must somehow detect how much rain has fallen, and more preferably other characteristics such as the intensity of the rainfall (i.e. amount of rainfall over a given period of time).

More complex precipitation measurement mechanisms are known that attempt to satisfy these needs. To date, such mechanisms collect the rainfall in collectors that have openings at the top and measure the total amount of collected rainfall using weight or other fluid volume measuring concepts. The use of a load cell to measure precipitation is discussed in U.S. Pat. No. 6,038,920, issued March 2000 to Gilbert, et al. A volume measuring mechanism that counts standard drops from a collected pool is discussed in U.S. Pat. No. 5,421,198, issued June 1995 to More, III, et al. All of these mechanisms are unnecessarily complex.

The majority of automatic irrigation systems used today do not have rain detectors. However, because of the increased need to conserve water, all automatic irrigation systems should have rain detectors. Rain detectors should as closely as possible simulate what occurs under natural conditions. Therefore, there should be no obstructions to the evaporation of water from the rain collector so that, after the rainfall has ceased, the irrigation system will be activated again at the appropriate time. What is needed is an effective, reasonably priced rain detector that simulates natural evaporation conditions as closely as possible. The following invention meets this need.

### SUMMARY OF THE INVENTION

The rain detector comprises a porous material, a sensor that detects rain absorption by the porous material and a switching mechanism that effects an execution of an irrigation application by an irrigation controller.

The porous material may be composed of brick, stone, concrete, wood, cloth fibers, chalk or any other substance that has porous properties.

The sensor may be an integral part of the switching mechanism or separated from the switching mechanism but connected to it.

Preferably the sensor is a compression device. The compression device may be a spring made of stainless steel, a compression load cell or any other compression device that can detect moisture absorption by the porous material.

Alternatively the sensor may be a bending load cell or any other type of sensor that can detect moisture absorption by the porous material.

In a preferred embodiment of the present invention, the sensor is an integral part of the switching mechanism. However, it is contemplate that the sensor may not be an integral part of the switching mechanism and instead be connected to the switching mechanism. The connection may be a hard wire or a wireless connection between the sensor and the switching mechanism.

The irrigation controller electrically operates at least one sprinkler valve. Preferably, when the sensor does not detect a set amount of absorbed rain held by the porous material, the switching mechanism will remain in the closed position providing an electrical connection between the irrigation controller and the at least one sprinkler valve, thereby allowing the execution of an irrigation application by the irrigation controller.

When the sensor detects a set amount of absorbed rain held by the porous material, the switching mechanism will be in the open position. When the switching mechanism is in the open position there is provided an electrical disconnection between the irrigation controller and the at least one sprinkler valve, thereby preventing the execution of an irrigation application by the irrigation controller.

In an alternative embodiment of the present invention, a microprocessor is programmed to receive a signal from the sensor when the sensor detects rain absorption by the porous material. The microprocessor may be an integral part of the rain detector or be disposed in the irrigation controller or a personal computer.

Preferably, the microprocessor is programmed to derive from the signals the quantity of rainwater absorbed by the porous material. Furthermore, when the rainfall has ceased, the microprocessor controls when the next scheduled irrigation will occur and the duration of the next scheduled irrigation.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a side view of the rain detector.

FIG. 2 is a schematic of an irrigation controller.

FIG. 3 is a block diagram of an automatic irrigation system with a rain detector according to an aspect of the present invention.

FIG. 4 is a block diagram of an alternative embodiment of an automatic irrigation system with a rain detector according to an aspect of the present invention.

FIG. 5 is a block diagram of a second alternative embodiment of an automatic irrigation system with a rain detector according to an aspect of the present invention.

### DETAILED DESCRIPTION

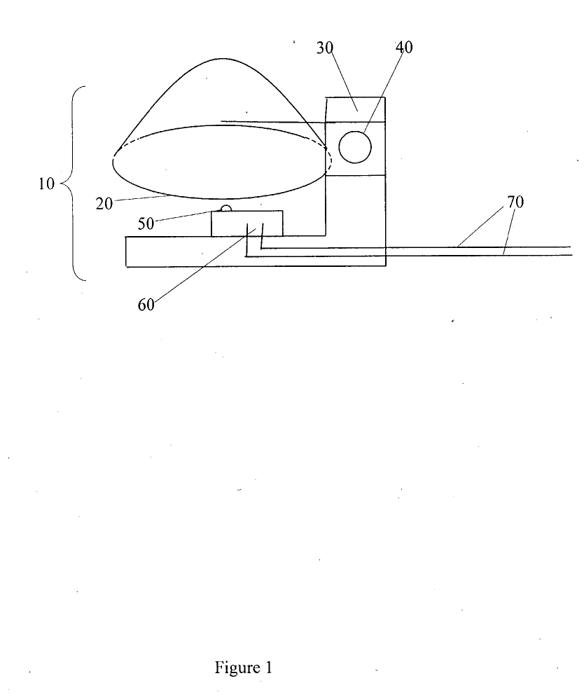

Referring first to FIG. 1, in a preferred embodiment of the present invention the rain detector 10 comprises a porous material 20 that is pivotally connected 40 to a support unit 30, allowing the porous material 20 to rotate. It is contemplated that the porous material may be placed on or attached to a metal, plastic or other structural base, which is pivotally connected 40 to the support unit 30. The porous material 20 can be of any substance that will absorb moisture and will hold the moisture for a period of time. The period of time will depend on the rate of evaporation of the moisture from the porous material. The porous material 20 can be composed of brick, stone, concrete, wood, cloth fibers, chalk or any other substance that has porous properties. In FIG. 1, the porous material 20 has a conical shape but it can be appreciated that the porous material 20 can consist of shapes other than a conical shape, such as, rectangular, pointed, and so forth. In a preferred embodiment of the present invention, there are no obstructions or coverings on the porous material 20 that would obstruct either the impact of the rainwater on the porous material 20 or impede the subsequent evaporation of the rainwater from the porous material 20.

Referring again to FIG. 1, a sensor 50 detects rain that is absorbed by the porous material 20. In this example the sensor 50 is a compression device that is located under the porous material 20. The compression device may be a spring made of stainless steel, a compression load cell or any other type of compression device. The sensor 50 may also be a mechanism other than a compression device, such as a bending load cell or other type of mechanism that can measure the variation in the moisture held by the porous material 20. It can be appreciated that the compression device or other type of sensor 50 could also be located in a position, other than under the porous material 20, as long as in a position, where it can detect when rain is absorbed by the porous material 20.

In FIG. 1 the porous material 20 is pivotally connected 40 to the support arm 30, however, it is contemplated that the porous material 20 could be solidly attached to the support arm 30 and a sensor, such as, a bending load cell could be used to measure the moisture absorbed by the porous material.

In FIG. 1, the sensor 50 is an integral part of a switching mechanism 60. However, it can be appreciated that the switching mechanism 60 may be housed separate from the sensor 50 and there be a direct wire connection between the sensor 50 and the switching mechanism 60. Additionally, it is contemplated, that the connection between the sensor 50 and the switching mechanism 60 may be through a wireless connection. The wireless connection, may consist of an optical, radio, hydraulic, ultrasonic or any other appropriate wireless link.

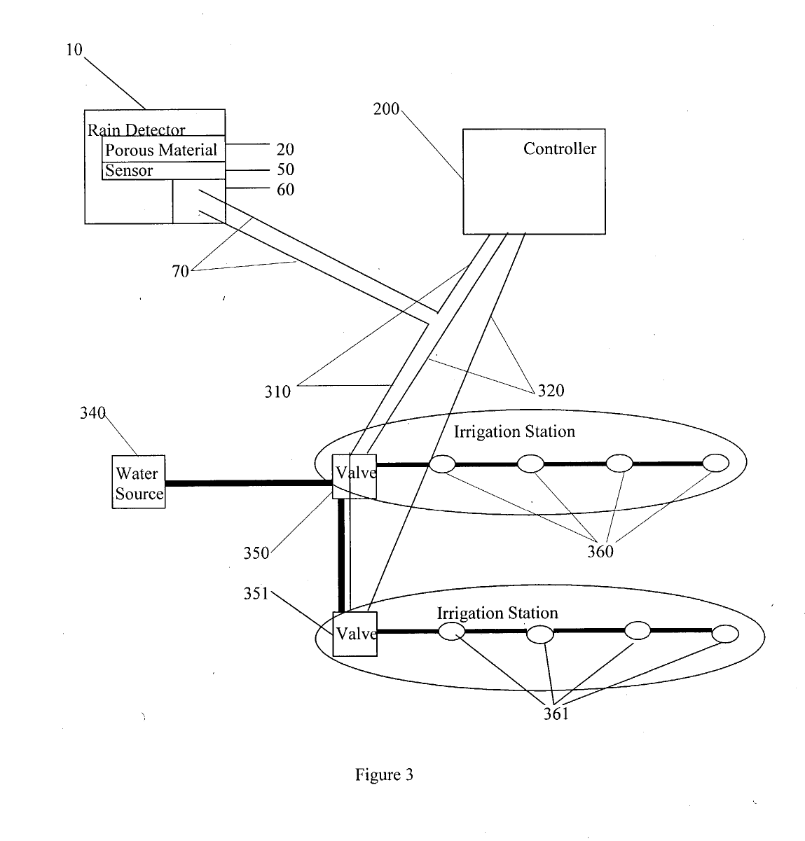

The switching mechanism 60 may be of various standard types, which are well known in the art and therefore are not described in greater detail here. The wires 70 from the switching mechanism 60 are connected to the common wire going from the controller to the irrigation valves, see FIG. 3.

Referring again to FIG. 1, when there is rain, the sensor 50, detects that rain has been absorbed by the porous material 20. Where the sensor 50 is a compression device disposed under the porous material 20, when the porous material 20 absorbs the rain, the added weight causes the porous material to rotate and apply pressure on the compression device. Since, in this example, the compression device is an integral part of the switching mechanism 60, when pressure is exerted on the compression device, it causes the switching mechanism 60 to be in the open position preventing the execution of an irrigation application by the irrigation controller. When there is no rain and no absorption of rainfall by the porous material 20 there is no pressure exerted on the compression device. When there is no pressure exerted on the compression device, the electrical switch remains in the closed position and the irrigation controller is enabled to execute irrigation applications as scheduled.

As mentioned above, it is contemplated that the sensor 50, may be a type of compression device, such as a compression load cell that could measure the variation in the pressure exerted by the porous material 20 as the moisture, held by the porous material 20, varies. A determination would be made of the correlation between moisture, absorbed by the porous material and varying rainfall amounts. The correlation determination could then be used to extrapolate the amount of rainfall that occurs during any given period of time.

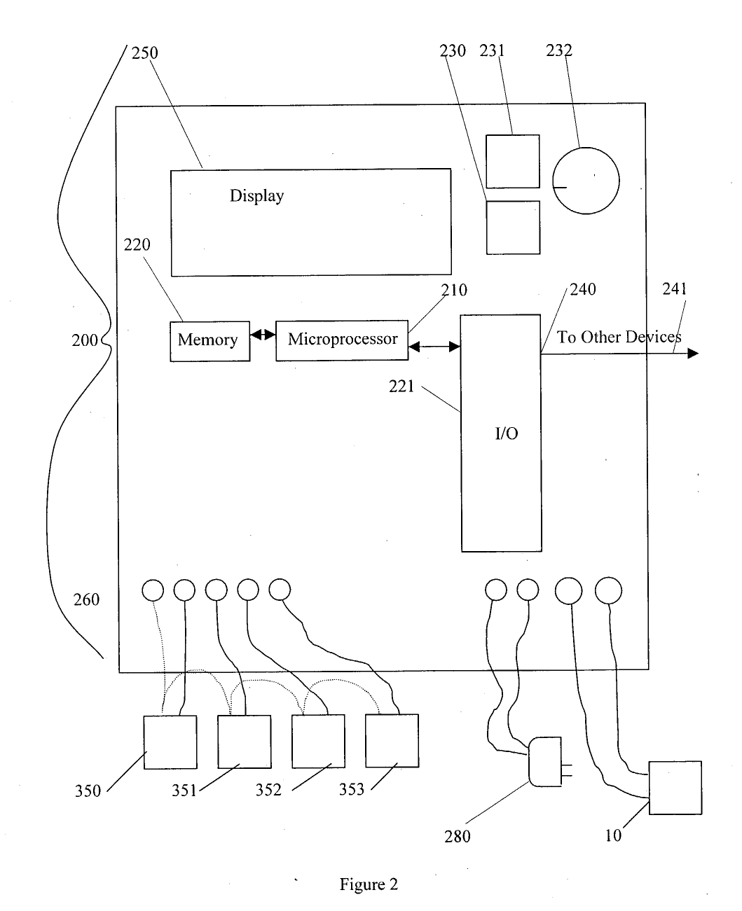

In FIG. 2, an irrigation controller 200 according to the present invention generally includes a microprocessor 210, an on-board memory 220, some manual input mechanisms 230 through 232 (e.g. buttons and/or knobs), a display screen 250, an input/output (I/O) circuitry 221 connected in a conventional manner, a communications port 240, a serial, parallel or other communications connection 241 coupling the irrigation controller to other mechanisms, such as personal computers, etc., electrical connectors 260, which are connected to a plurality of irrigation valves 350 through 353, a power supply 280, and a rain detection mechanism 10. Each of these components by itself is well known in the electronic industry.

In FIG. 3, a switching mechanism 60 disposed in the housing of the rain detector 10, would provide an electrical connection between the controller 200 and the irrigation valves 350 and 351. From the controller 200 parallel electrical control wires 320 go to each irrigation valve 350 and 351. There is generally a common return wire 310 that goes from the irrigation valves 350 and 351 back to the controller 200. In a preferred embodiment of the present invention, the switching mechanism 60 of the rain detector 10 is electrically connected 70 in series with the common return wire 310 from the valves to the controller. When the sensor 50 does not detect a set quantity of absorbed rain held by the porous material 20, the switching mechanism 60 electrically connects the controller 200 to the irrigation valves 350 and 351 allowing a scheduled irrigation of the landscape to occur. It is contemplated that the sensor 50 will be set to trigger the switching mechanism to change from either the open to closed position or from the closed to open position based on a set amount of rain being absorbed and held by the porous material 20. Preferably, the triggering of the switching mechanism to change from either the open to closed position or from the closed to open position will occur when a rain amount of 1/8 inch has occurred. However, the triggering of the switching mechanism might be set to occur with rain of a lesser or greater amount than 1/8 inch. During the scheduled irrigation, the irrigation valves 350 and 351 will open and water will flow from a water source 340 to a plurality of sprinkler heads 360 and 361 to irrigate the landscape. Although, two irrigation valves 350 and 351 and two irrigation stations 360 and 361 are shown, it can be appreciated that the irrigation controller can control any number of irrigation valves and irrigation stations. It should also be noted that although wired communications are depicted, wireless communications may be substituted between the rain detector and the irrigation controller. The wireless communication may be accomplished by a radio, a pager, a telephone or other appropriate wireless communication mechanism.

In FIG. 3 the switching mechanism is housed with the rain detector. However, in an alternative embodiment of the invention (not shown), it is contemplated that the switching mechanism would be located near the irrigation controller or disposed in the irrigation controller and a signal from the sensor would be transmitted to the switching mechanism. Preferably, the signal would be transmitted via wireless communication methods, such as, a radio, a pager, a telephone or other appropriate wireless communication mechanism. Alternatively, the signal could be transmitted from the sensor to the switching mechanism, located near or disposed in the irrigation controller, via a direct wire connection.

Referring again to FIG. 3, when a set amount of moisture, from rainfall, is absorbed by the porous material 20, the switching mechanism 60 electrically disconnects the controller 200 from the irrigation valves 350 and 351 preventing the execution of the scheduled irrigation. The next scheduled irrigation will not occur until adequate moisture has evaporated from the porous material 20, at which point the sensor 50 will trigger the switching mechanism 60 to be in the closed position and irrigations will again be executed by the irrigation controller 200.

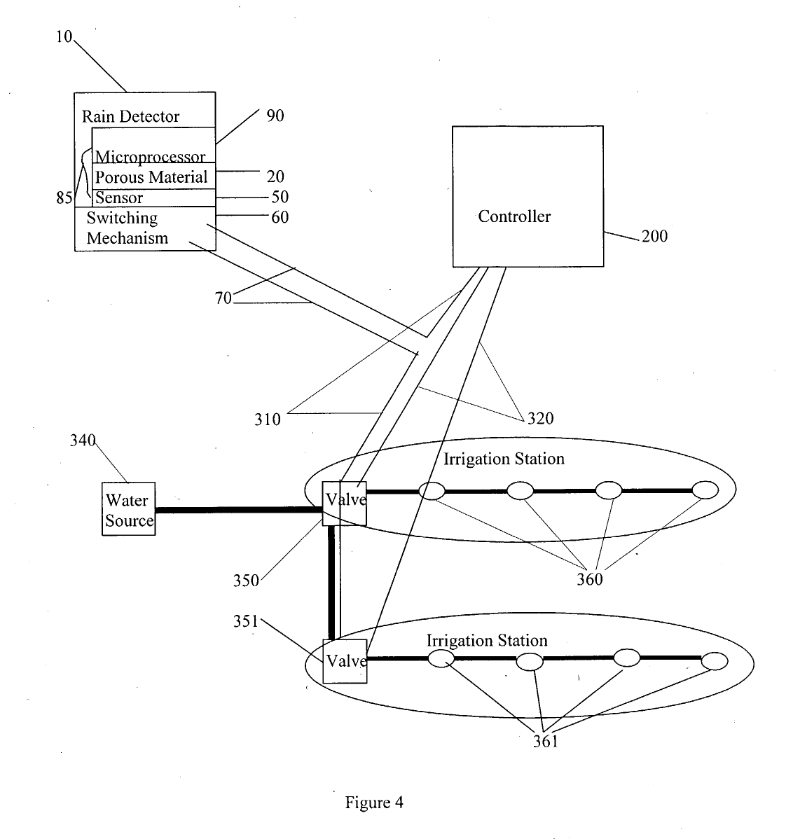

FIG. 4 is an alternative embodiment of the present invention in which a microprocessor 90 is disposed in the rain detector 10 and quantifies the amount of rainfall that occurs during any period of time based on the pressure exerted by the moisture, held by the porous material 20 and detected by the sensor 50. It can be appreciated that the microprocessor could be disposed in the irrigation controller or even in a mechanism separate from the rain detector or irrigation controller, for example, in a personal computer. The microprocessor 90 is connected 85 to the sensor 50. The connection may be by a direct connection, such as through a wire or if the microprocessor was disposed in the irrigation controller or a personal computer it could be connected by a wireless connection, such as a radio, a pager, a telephone or other appropriate wireless communication mechanism. The microprocessor 90 is preprogrammed to analyze the signals from the sensor 50 and to derive there from, the amount of moisture that is held by the porous material 20. As mentioned above, preferably a relationship will be determined between the moisture absorbed by the porous material 20 and the rainfall that occurs during any given period of time. Based on the relationship determined between the moisture absorbed by the porous material 20 and rainfall, the microprocessor 90 will be programmed to extrapolate the rainfall that occurred based on the moisture the sensor detected was held by the porous material 20.

Referring again to FIG. 4, based on the amount of rainwater absorbed by the porous material 20, the microprocessor 90 controls when the next scheduled irrigation will occur and the duration of the next scheduled irrigation by causing the switching mechanism 60 to be in the open or closed position. The microprocessor 90 is connected 80 to the switching mechanism 60. The connection may be a wired or wireless connection. The wireless connection may be via a radio, a pager, a telephone or other appropriate wireless communication mechanism. The next scheduled irrigation will not occur until the sensor 50 can no longer detect a set amount of absorbed moisture, held by the porous material 20. When no moisture is detected above a set amount, the switching mechanism 60 will be in a closed position and the irrigation system can operate. In a preferred embodiment of the present invention, the microprocessor 90 will then control when the next scheduled irrigation will occur and the duration of the next scheduled irrigation.

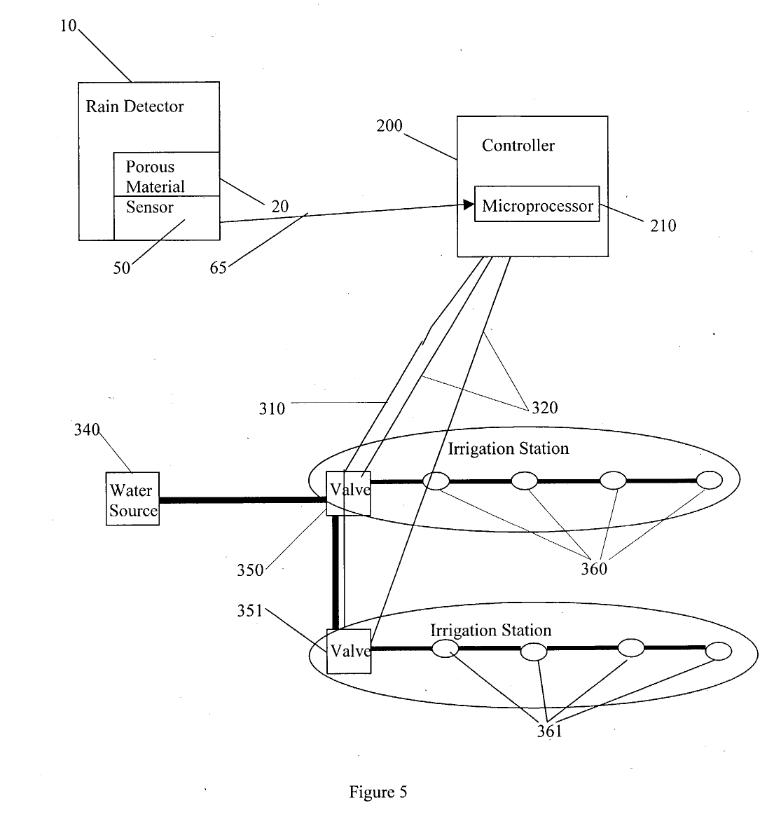

Prior discussion has involved the use of a switching mechanism as an integral part of the rain detector in preventing or enabling the execution of irrigation applications by the irrigation controller. FIG. 5 is an alternative embodiment of the present invention that does not involve a switching mechanism. It is contemplated, in this alternative embodiment of the present invention, that a signal will be transmitted 65 from the sensor 50 to the microprocessor 210, disposed in the irrigation controller. The transmission 65 can be either through a wired or wireless communication. The wireless communication may be by radio, pager, telephone or other appropriate wireless communication mechanism

When the sensor 50 detects moisture, from rainfall that has been absorbed by the porous material 20, a signal will be transmitted to the microprocessor 210. The microprocessor 210 will be programmed to use the signal to change the next scheduled irrigation to a later scheduled irrigation by the irrigation controller 200. In a preferred embodiment of the present invention, the sensor 50 will also send a signal to the microprocessor 210, when the moisture held by the porous material 20 has evaporated down to a certain level, at which time the microprocessor would permit the irrigation controller 200 to execute a new scheduled irrigation application.

In a preferred embodiment of the present invention, after the rainfall has stopped, the microprocessor 210 will not only control when the next scheduled irrigation will occur but will also control the duration of the next scheduled irrigation. It is contemplated that the microprocessor 210 will be programmed to analyze the signals from the sensor 50 and to derive there from, the amount of moisture that is held by the porous material 20. As mentioned above, preferably a relationship will be determined between the moisture absorbed by the porous material 20 and the rainfall that occurs during any given period of time. Based on the relationship determined between the moisture absorbed by the porous material 20 and rainfall, the microprocessor 210 will be programmed to extrapolate the rainfall that occurred, based on the signals the microprocessor 210 receives from the sensor 50. In a preferred embodiment of the present invention, the microprocessor 210 will be programmed to use this information to both control when the next scheduled irrigation will occur and to also control the duration of the next scheduled irrigation.

Thus, specific embodiments and applications of rain detection have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A rain detector comprising:
a porous material;
a sensor that detects rain absorption by the porous material; and
a switching mechanism that effects the execution of an irrigation application by an irrigation controller.

2. The rain detector of claim 1, wherein the porous material is composed of brick.

3. The rain detector of claim 1, wherein the sensor is a compression device.

4. The rain detector of claim 3, wherein the compression device is a compression load cell.

5. The rain detector of claim 1, wherein the sensor is a bending load cell.

6. The rain detector of claim 1, wherein the sensor is an integral part of the switching mechanism.

7. The rain detector of claim 1, wherein the sensor is not an integral part of the switching mechanism but is connected to the switching mechanism.

8. The rain detector of claim 7, wherein the connection is a hard wire connection between the sensor and the switching mechanism.

9. The rain detector of claim 7, wherein the connection is a wireless connection between the sensor and the switching mechanism.

10. The rain detector of claim 1, wherein the irrigation controller electrically operates at least one sprinkler valve.

11. The rain detector of claim 1, wherein, when the sensor does not detect rain absorption by the porous material the switching mechanism will remain in the closed position.

12. The rain detector of claim 11, wherein, when the switching mechanism is in the closed position there is provided an electrical connection between the irrigation controller and at least one sprinkler valve, thereby allowing the execution of an irrigation application by the irrigation controller.

13. The rain detector of claim 1, wherein, when the sensor detects rain absorption by the porous material the switching mechanism will be in the open position.

14. The rain detector of claim 13, wherein, when the switching mechanism is in the open position there is provided an electrical disconnection between the irrigation controller and at least one sprinkler valve, thereby preventing the execution of an irrigation application by the irrigation controller.

15. The rain detector of claim 1, further comprising a microprocessor that is programmed to receive a signal from the sensor when the sensor detects rain absorption by the porous material.

16. The rain detector of claim 15, wherein the microprocessor is an integral part of the rain detector.

17. The rain detector of claim 15, wherein the microprocessor is disposed in the irrigation controller.

18. The rain detector of claim 15, wherein the microprocessor is programmed to derive from the signals the quantity of rainwater absorbed by the porous material.

19. The rain detector of claim 15, wherein, after the rainfall has ceased, the microprocessor controls when the next scheduled irrigation will occur and the duration of the next scheduled irrigation.

20. A rain detector comprising:
a porous material;
a sensor that detects rain absorption by the porous material; and
a microprocessor, disposed in an irrigation controller, that receives a signal from the sensor to effect an execution of an irrigation application by the irrigation controller.
